(19) United States
(12) Patent Application Publication
(10) Pub. No.: US 2006/0247987 A1
(43) Pub. Date: Nov. 2, 2006

(54) Methods and apparatus for managing cash flow

(75) Inventors: Anthony T. Busch, Appleton, WI (US); Daniel Schroeder, Hortonville, WI (US)

Correspondence Address: GODFREY & KAHN S.C., 780 NORTH WATER STREET, MILWAUKEE, WI, 53202, US

(73) Assignee: Priora Cash Flow Management, LLC

(21) Appl. No.: 11/117,027

(22) Filed: Apr. 28, 2005

(51) Int. Cl. G07F 19/00; G07B 17/00

(52) U.S. Cl. 705/30

(57) ABSTRACT

A method and product for budgeting and/or managing cash flow includes entry of company information, assumptions, debt schedule, borrower's certificate and monthly data into a software program. The assumptions include cash on hand, cash receipts and cash paid out, among others. The information entered into the software is manipulated and stored in monthly ledgers for further display. Also provided is a calculation, based on actual part year figures for receipts, of remaining monthly adjustments needed to achieve predetermined budget figures. The product further provides a debt consolidation calculator for calculating the savings from the consolidation of at least two existing loans, and for calculating the possible savings based on at least two different weighted averages, the weighted average of the interest rates of the loans, and the weighted average of the interest rates considered together with the weighted average of the term of each of the loans.

### BACKGROUND OF THE INVENTION

The present invention relates generally to financial management and more specifically to a method of managing cash flow, which enables a person to have ready and accurate information relating to cash flow, whether on a personal basis or in a business.

There are several financial management software packages in the art. For example, many existing accounting packages, such as Quicken and QuickBooks, from Intuit, and Peachtree Accounting, provide functionality in the sense of tracking expenses historically, and providing budgeting ability. However, it appears that none of these software packages provides a monthly comparison of budget figures to actual figures to produce a variance, which tells a user what adjustments need to be made to the remaining months of the fiscal year to achieve a targeted budget. Further, it appears that none of these software packages provides loan ratios in chart form. Additionally, it appears that none of these software packages calculates the remaining balance for each loan and totals all loans by month, the term loan principal payments and the term loan interest payments, and brings those totals into the appropriate area in the budget for the appropriate month. Even further, none of these software packages appears to incorporate inventory and accounts receivable ratios into monthly transaction data, and none of them includes a debt consolidation calculator, which provides consolidated loan figures based on weighted average loan interest rate alone, or weighted average interest rate plus weighted average of the amortization, to assist a user to know the current average rate for several different loans or loan proposals, possibly from different lenders. Finally, it appears that none of these software packages includes an accounts receivable configuration schedule, which allows a user to change the percentage of funds planned to be received for each month of a fiscal year.

Accordingly, there is a clearly felt need in the art for a method of and product for managing cash flow, which enables a user to ensure the profitability of a business or enables a user to communicate a level of financial performance to others, such as potential lenders or investors, in a tangible format.

### SUMMARY OF THE INVENTION

The present invention provides a method of and product for managing cash flow, which allows an entity, such as a business owner, to communicate the profitability or cash flow capability of an enterprise. The method of managing cash flow includes entry of entity identifying information, assumptions, debt schedule, borrower's certificate and monthly data into a software program. Some of the data to be entered includes cash on hand, cash receipts and cash paid out. The data entered is manipulated and stored for further display and for further calculation. The figures displayed can include budget figures, actual figures describing actual cash flow events, a description of variances between actual and budget figures, a debt consolidation calculator, an accounts receivable configuration schedule and a selection of charts. The charts may include actual cash position, current ratio, a leverage ratio, a debt service coverage ratio, net credit line availability, working capital position, and monthly cash receipts/expenditures. In general this method of managing cash flow would be used in conjunction with conventional financial statements, such as a monthly income statement and a balance sheet.

The present invention provides a budget adjustment calculator, which includes means for determining the difference between a budget year-to-date figure for a particular fiscal year and month, and an actual year-to-date figure for that same fiscal year and month, for at least one account, to determine a variance year-to-date figure for that fiscal year and month; and means for dividing the variance year-to-date figure by the number of months, if any, remaining in the fiscal year to produce a budget impact figure.

The present invention further provides a debt consolidation calculator for calculating the savings from the consolidating at least two existing loans, each of the existing loans having a remaining principal balance, an interest rate, a periodic payment amount, and a remaining number of payments. The debt consolidation calculator includes a means for summing all remaining principal balances to provide a new consolidated loan amount. A calculator is provided for calculating a weighted average of the interest rates of all the existing loans to provide a new consolidated loan rate, and for calculating a weighted average of the remaining number of payments of the existing loans to provide a new consolidated remaining number of payments. Finally, means are provided for using the new consolidated loan amount, the new consolidated loan rate and the new consolidated remaining number of payments to calculate a new consolidated periodic payment amount.

These and additional objects, advantages, features and benefits of the present invention will become apparent from the following specification.

### BRIEF DESCRIPTION OF THE DRAWINGS

FIG. 1 is a screen shot of a main menu screen for a program for managing cash flow in accordance with the present invention.

FIG. 2 is a screen shot of a screen for entering company information for the program for managing cash flow in accordance with the present invention.

FIG. 3 is a screen shot of a screen for entering assumptions for the program for managing cash flow in accordance with the present invention.

FIGS. 4A and 4B together form a screen shot of a screen for entering a schedule of debt payments, an amortization calculator for calculating loan terms, a table showing remaining loan balances, and tables for showing the interest and principal portion of each payment made, for the program for managing cash flow in accordance with the present invention.

FIG. 5 is a screen shot of a screen for entering a borrower's certificate for the program for managing cash flow in accordance with the present invention.

FIG. 6 is a screen shot of a screen for entering a personal financial statement for the program for managing cash flow in accordance with the present invention.

FIG. 7 is a screen shot of a monthly cash flow projection ledger page for the program for managing cash flow in accordance with the present invention.

FIG. 8 is a screen shot of a 12-month budget cash summary of the program for managing cash flow in accordance with the present invention.

FIG. 9 is a screen shot of a 12-month actual cash summary as displayed in the program for managing cash flow in accordance with the present invention.

FIG. 10 is a screen shot of a full set of monthly deletion buttons as displayed in the program for managing cash flow in accordance with the present invention.

FIG. 11 is a screen shot of a summary of variances between budgeted cash flow and actual cash flow as displayed in the program for managing cash flow in accordance with the present invention.

FIG. 12 is a screen shot of the screen displayed by the debt consolidation calculator function of the program for managing cash flow in accordance with the present invention.

FIG. 13 is a screen shot of an accounts receivable configuration schedule of the program for managing cash flow in accordance with the present invention.

FIG. 14 is a screen shot of an actual cash position bar chart as displayed by the program for managing cash flow in accordance with the present invention.

FIG. 15 is a screen shot of a quick ratio bar chart as displayed by the program for managing cash flow in accordance with the present invention.

FIG. 16 is a screen shot of a current ratio bar chart as displayed by the program for managing cash flow in accordance with the present invention.

FIG. 17 is a screen shot of a working capital position bar chart as displayed by the program for managing cash flow in accordance with the present invention.

FIG. 18 is a screen shot of monthly cash receipts and expenditures bar chart as displayed by the program for managing cash flow in accordance with the present invention.

FIG. 19 is a screen shot of a leverage ratios bar chart as displayed by the program for managing cash flow in accordance with the present invention.

FIG. 20 is a screen shot of a debt service coverage ratios bar chart as displayed by the program for managing cash flow in accordance with the present invention.

FIG. 21 is a screen shot of a net credit line availability bar chart as displayed by the program for managing cash flow in accordance with the present invention.

FIG. 22 is a screen shot of a menu allowing the user to select one of the above charts, shown in FIGS. 14 through 21.

FIG. 23 is a screen shot of a portion of the help screens supplied with the program for managing cash flow in accordance with the present invention.

### DETAILED DESCRIPTION OF THE PREFERRED EMBODIMENTS

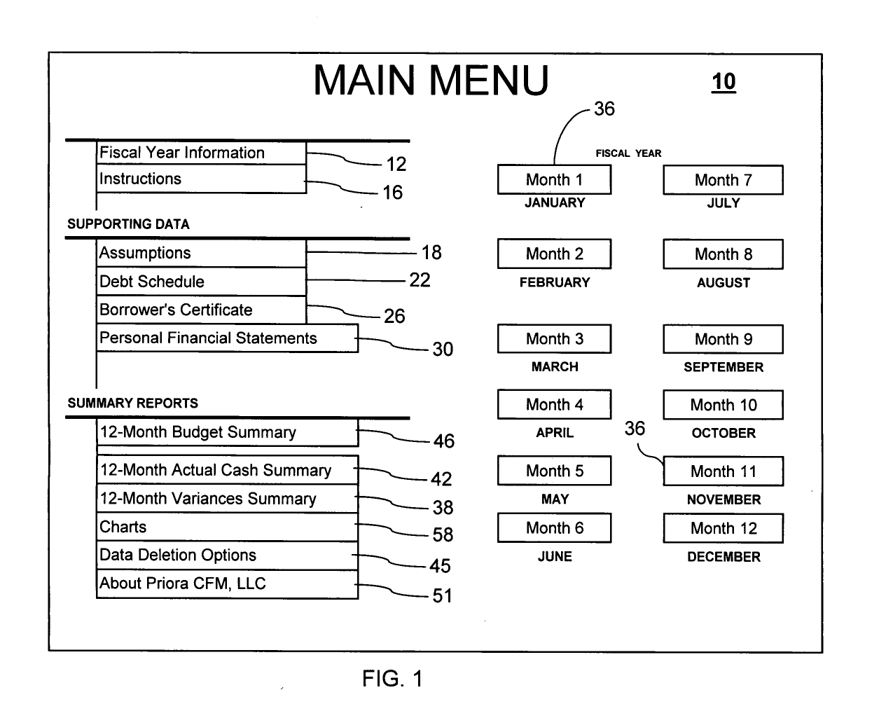

With reference now to the drawing figures, and particularly to FIG. 1, there is shown a screen shot of a main menu screen 10 for use in a method of managing cash flow. The method of managing cash flow includes entry of company information, assumptions, debt schedule, borrower's certificate and monthly data into a software program. The program software in its present embodiment is built on Excel, a product of Microsoft Corporation, but may also be constructed using other environments, such as Lotus 1-2-3; Quattro Pro from Corel; or other languages, such as C++, C#, Visual Basic; or Java; or environments not yet known or devised. Microsoft, Excel, Lotus 1-2-3, Quattro Pro, Corel, Visual Basic and Java are federally registered trademarks owned by the respective companies.

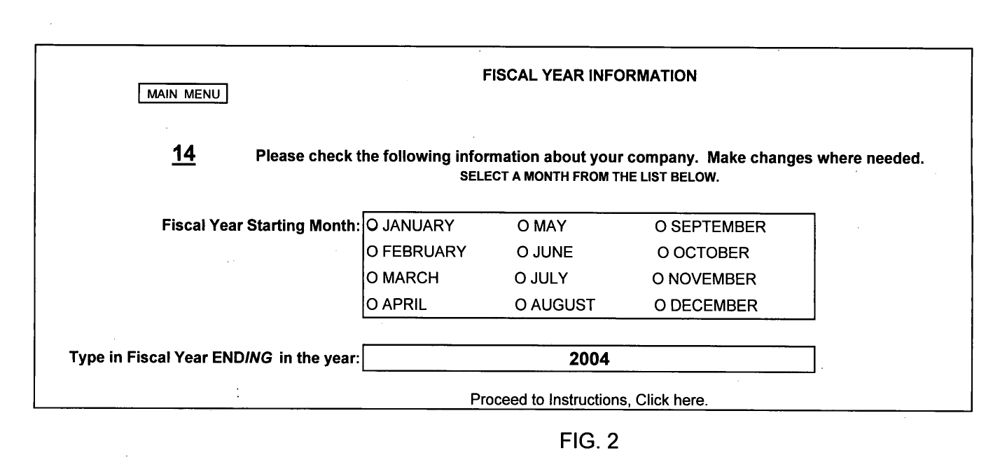

In order to reach a company information screen 14, as shown in FIG. 2, a “Fiscal Year Information ” button 12 (FIG. 1) is clicked on. Fiscal year information, specifically the year in which the fiscal year begins and the first month of the fiscal year, is entered into the company information screen 14.

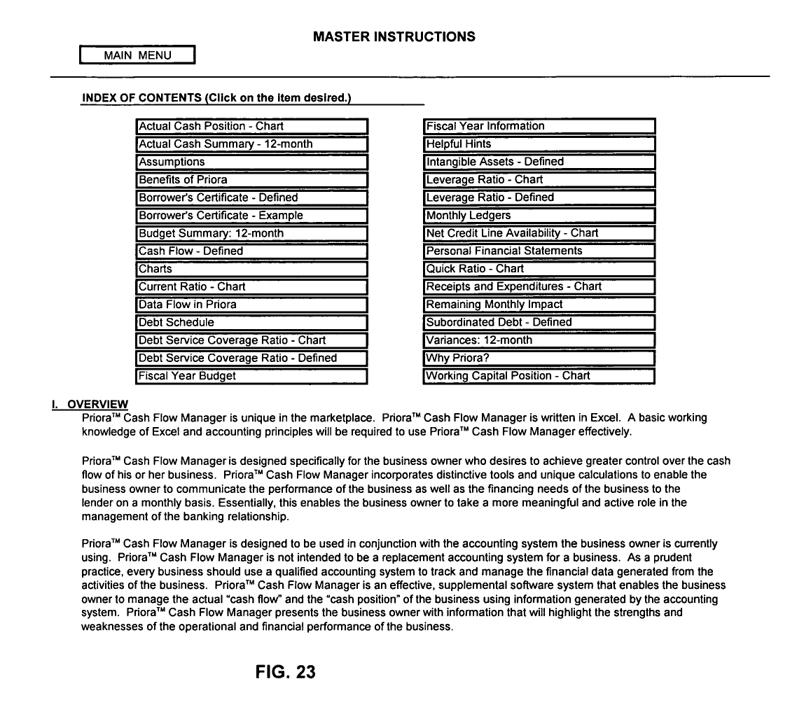

An “Instructions” button 16 (FIG. 1) can be clicked on by the user to display a screen (FIG. 23) with instructions on entering information, using the program and operating the program. This same set of instructions may be accessed from other areas, including the area labeled “Proceed to Instructions. Click here.” in FIG. 2.

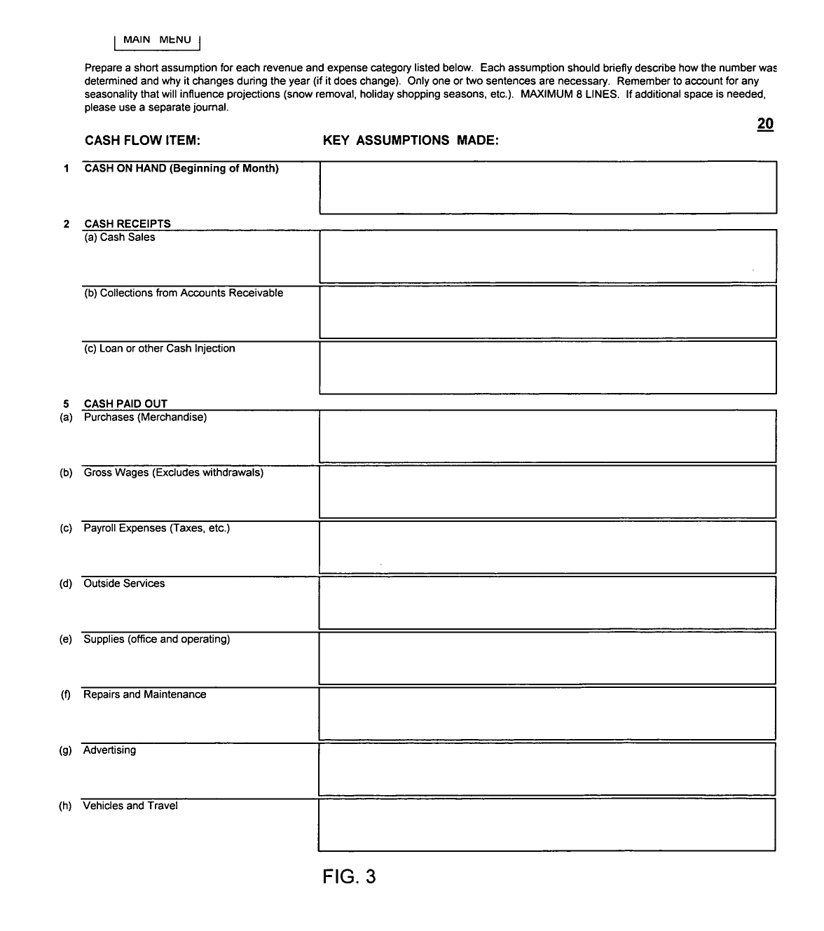

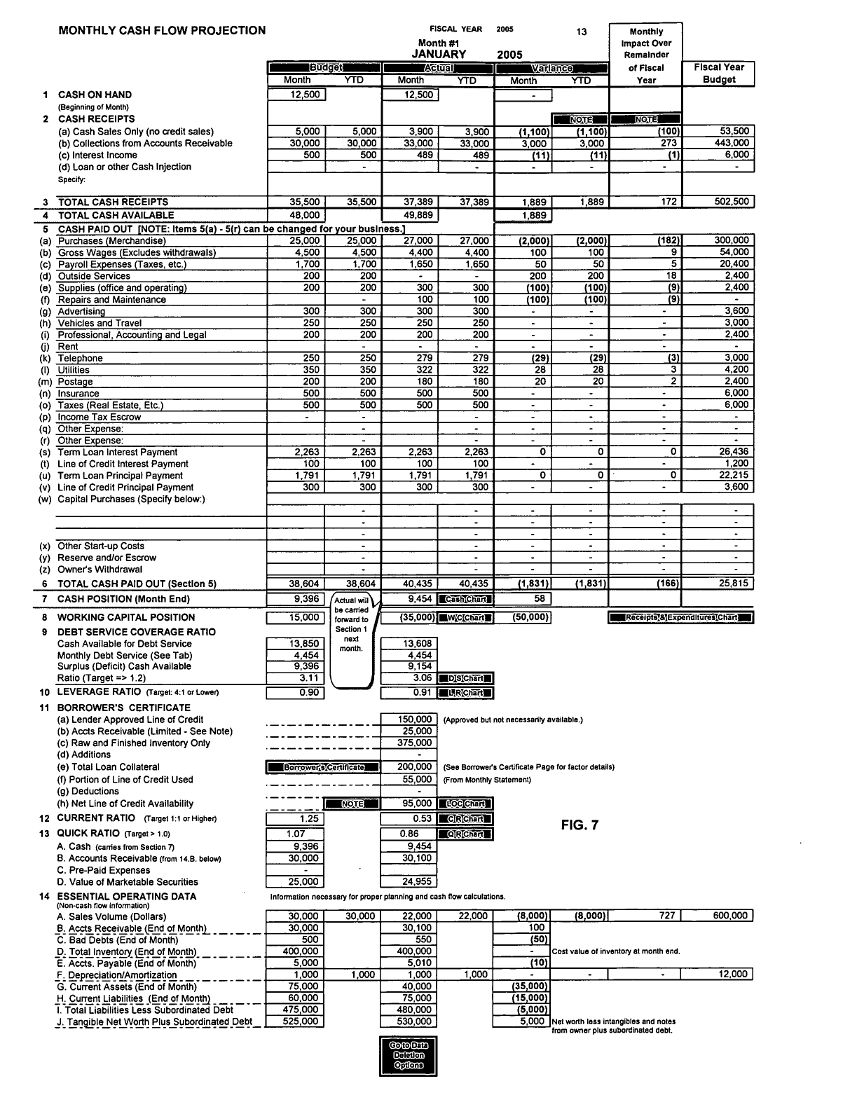

An “Assumptions” button 18 (FIG. 1) is clicked on by the user to reach an assumptions input screen, part of which is shown in FIG. 3. In this area, written assumptions are entered, based on reasons why a particular value of numeric data is entered in the monthly area, described below. Each area has a general correlation to a particular one of the data input cells in FIG. 7.

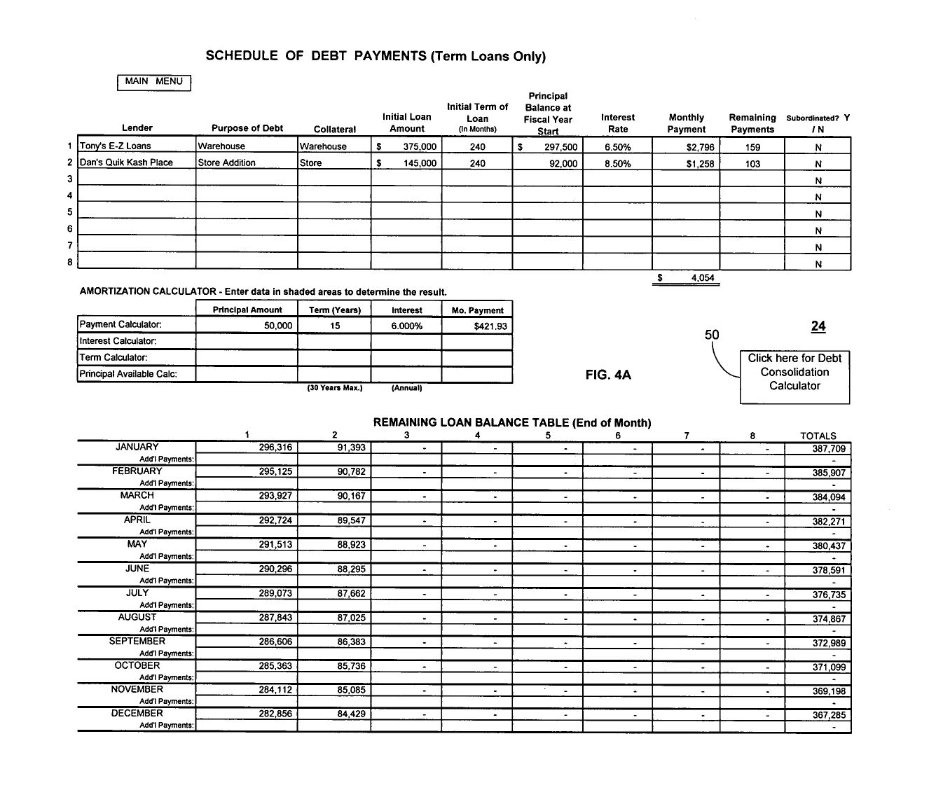

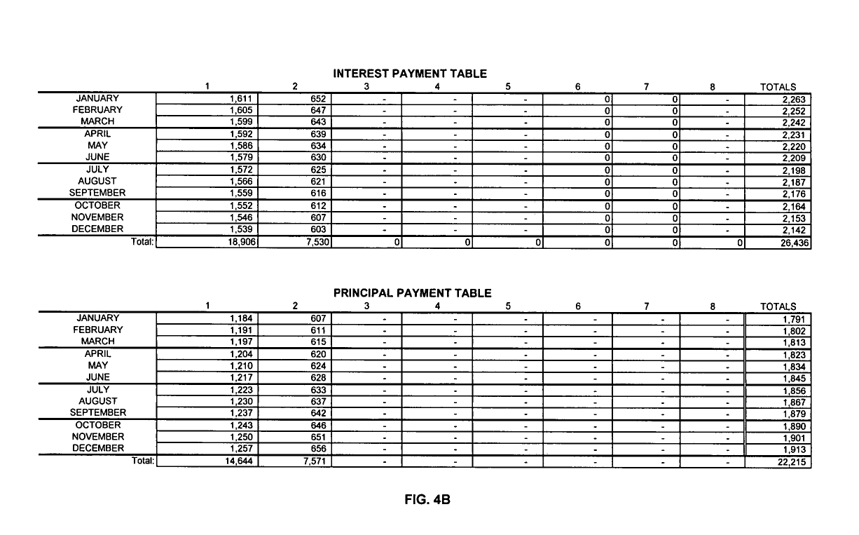

A “Debt Schedule” button 22 (FIG. 1) is clicked on by the user to reach a schedule of debt payments screen 24, shown divided between FIGS. 4A and 4B. Information concerning any existing or proposed term loans is entered into the Schedule of Debt Payments table on the Schedule of Debt Payments screen 24. The Schedule of Debt Payments screen 24 calculates the remaining principal balance as well as the principal and interest portions of each loan payment for each month of a fiscal year. The Schedule of Debt Payments screen 24 has the ability to track up to eight individual term loans and can total the monthly payments for all the loans entered. An amortization calculator on the Schedule of Debt Payments screen 24 can be used to solve for any of four components of debt: principal, term (in months, in this embodiment), interest rate (annual, in this embodiment), or periodic payment (monthly in this embodiment). The Remaining Loan Balance Table on the Schedule of Debt Payments screen 24 tracks the remaining principal loan balance for each of the loans entered, by each month of the fiscal year, and totals the figures for all the loans, for a running month-by-month total term loan balance during the year. By use of the Remaining Loan Balance Table, the Schedule of Debt Payments screen 24 can be adjusted at any time of the year for any loan to reflect the new remaining principal balance after the application of a principal payment in excess of the regularly scheduled principal payment for that loan for that month. The Interest Payment Table and the Principal Payment Table show the interest portion, and principal portion, of each payment of each of the eight loans identified in the Schedule of Debt Payments table, above in FIG. 4. These interest and principal figures from the Interest Payment Table and the Principal Payment Table are automatically reported into a monthly cash flow projection screen 34 (FIG. 7), which is explained in more detail below.

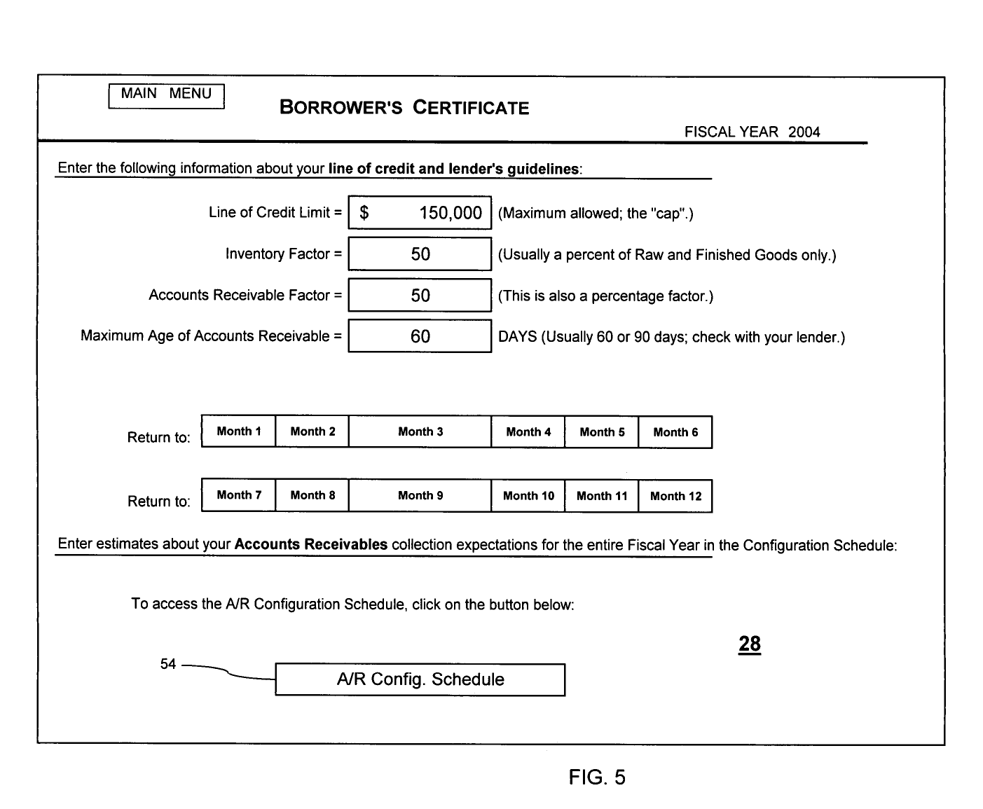

A “Borrower's Certificate” button 26 (FIG. 1) can be clicked on by the user to reach a borrower's certificate screen 28, shown in FIG. 5, where criteria negotiated with a lender for advances under a working capital line of credit are entered. The criteria that can be entered include Inventory Factor, Accounts Receivable Factor and Maximum Age of Accounts Receivable. The Maximum Age of Accounts Receivable figure is entered as 60 days in borrower's certificate screen 28.

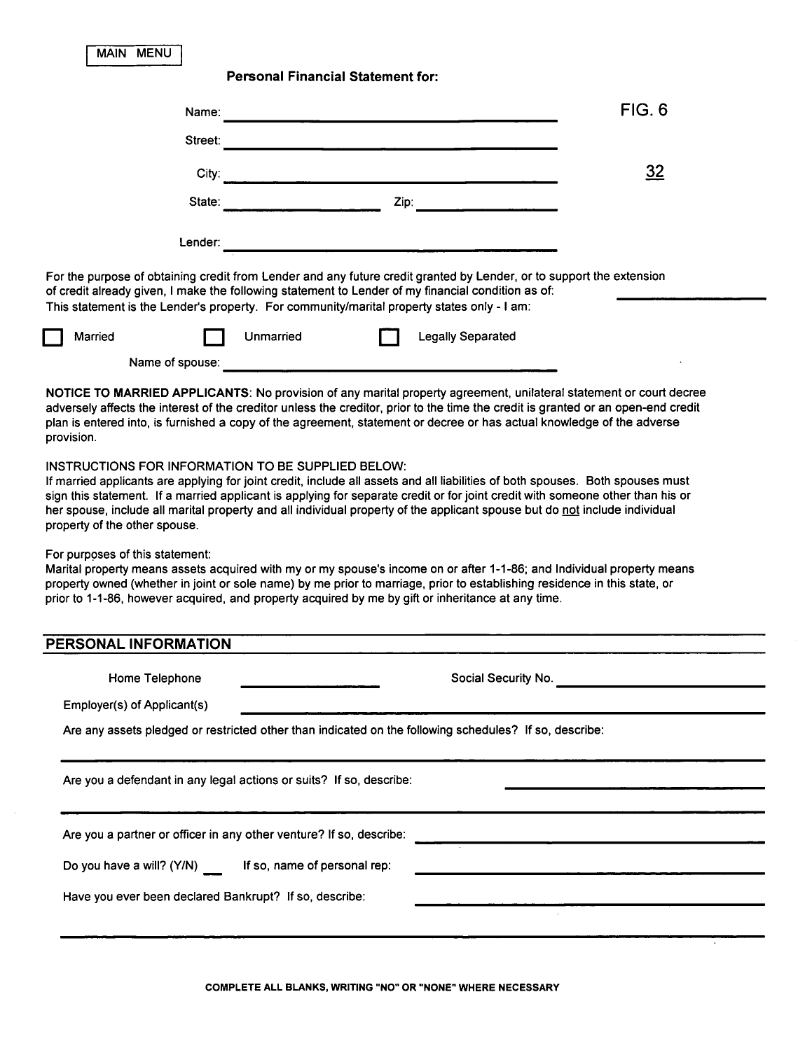

A “Personal Financial Statements” button 30 (FIG. 1) can be clicked on by the user to reach a personal financial statements screen 32, shown in FIG. 6, where personal financial information of the user is entered, for later use and provision to potential lenders.

With reference to FIG. 7, a monthly cash flow projection screen 34 is displayed for a particular month, when a particular month button 36 is clicked on in FIG. 1. The particular month entered as the Fiscal Year Starting Month in FIG. 2 automatically appears as Month 1 in FIG. 7, the next month as Month 2 in FIG. 7, and so on. The information entered into the software program in FIGS. 2, 4, 5 and 13 is manipulated and stored in the monthly cash flow projection screen 34 (FIG. 7) for further access and display in other screens and charts. All the information entered in FIGS. 2, 4, 5 and 13 appear in the “Budget” column. The actual information, of the same type as entered as budget figures in FIGS. 2, 4, 5 and 13, is manually entered in the respective line of the “Actual” column for that particular month in FIG. 7, once the actual numbers are known. The shaded cells are where the information is entered in FIG. 7, whereas the unshaded cells obtain their values from other figures, or from other areas of the table shown in FIG. 7. The “Variance” column then displays the difference between the “Budget” column and the “Actual” column for each line item of information, both on a monthly and year-to-date basis.

One of the unique and valuable features of the invention is the “Monthly Impact Over Remainder of Fiscal Year” column of the monthly ledger. In this column, at the rows where there are to be budget figures, actual figures and variance figures in the earlier columns, the invention provides a budget adjustment calculator, which calculates how much more or less an account must perform per month for each of the remaining months in the fiscal year, in order to achieve budget during the rest of the year. This budget adjustment figure is determined by dividing the “Variance” year-to-date figure (whether it is a plus or minus figure) by the number of months left in the fiscal year. The result of that division (again whether it is a plus or minus figure) is displayed in each cell of the column. The calculation and display of the adjustment needed to achieve budget for each line, in dollars, is more meaningful than a straight percentage figure because it provides the actual per month dollar amount. That is, it is a more clear and specific goal for a user to attempt to reach.

Continuing with the description of the preferred embodiments of the invention, the Total Cash Receipts figures are the sums of the cash inflows in the rows above, namely, Cash Sales, Collections from Accounts Receivable, Interest Income, and Loan or other Cash Injection. The Total Cash Available figures are the sums of the Cash On Hand figures and the Total Cash Receipts figures. In the Budget column, the Term Loan Interest Payment row (row 5(s)) tracks the total interest portion of all term loans by month, that is, it automatically provides a total interest figure for all the term loans entered in the Schedule of Debt Payments 24 (FIG. 4) by month. The Term Loan Principal Payment row (row 5(u)), in the Budget column, tracks the total of all the principal portions of all term loans by month, that is, it automatically provides the total principal of all the term loans entered in the Schedule of Debt Payments 24 (FIG. 4) by month.

The Total Cash Paid Out row (row 6) shows the sum of the rows from Section 5 of screen 34. The cash position at the end of a month, labeled “Cash Position (Month End)” (row 7) is the difference between the Total Cash Paid Out (row 6) and the Total Cash Available (Row 4).

The Working Capital Position (row 8) is the difference between Current Assets (row 14G) and Current Liabilities (row 14H).

The Debt Service Coverage Ratio (row 9) is the ratio of the Cash Available for Debt Service figure (which comes from the total of Row 7 plus Row 5(s) plus Row 5(t) plus Row 5(u)) to the Monthly Debt Service figure. The Debt Service Coverage Ratio should be greater than or equal to 1.2:1 to ensure sufficient debt service coverage.

The Leverage Ratio (row 10) is the ratio of the Total Liabilities less Subordinated Debt, to Net Worth plus Subordinated Debt less Intangible Assets less Notes Receivable from Owners and/or Employees. The Leverage Ratio should be equal to or less than 4:1 in a well-managed business, although variances can occur by industry.

Total Loan Collateral (row 11(e)) is the sum of the value of raw and finished goods multiplied by the Inventory Factor (from FIG. 5); plus Accounts Receivable multiplied by the Accounts Receivable Factor (also from FIG. 5); plus Additions (row 11(d)). Additions could be made to the Total Loan Collateral in instances where a borrower does not have sufficient value in inventory and accounts receivable alone to sufficiently secure a particular loan amount, and the lender requires the borrower to put up additional property as collateral. There also can be Deductions (row 11(g)), in a situation such as where a borrower has excess value in inventory and/or accounts receivable to sufficiently secure a particular amount of loan. In that case, a borrower could grant a lien, to secure a particular loan amount, on only a portion of the inventory and/or accounts receivable. Net Line of Credit Availability (row 11(h)) is the difference between the Portion of Line of Credit Used (row 11(f)) and the lesser of Total Loan Collateral and the Lender Approved Line of Credit (row 11(a)). The concept of including Additions and Deductions into the formulas for Net Line of Credit Availability is a novel and useful part of the present invention. The ability of the present invention to accommodate these Additions and Deductions provides a level of latitude and flexibility not available with previous methods and apparatus. Such latitude and flexibility are important because such arrangements are often temporary in nature, and can be subject to change during the term of any particular loan secured by these Additions and Deductions.

The Current Ratio (row 12) is the ratio of Current Assets to Current Liabilities. The Current Ratio should be greater than 1:1.

The Quick Ratio (row 13) is the ratio of a) the sum of Cash, Accounts Receivables, pre-paid expenses and the value of marketable securities, to b) Current Liabilities. The Quick Ratio should be greater than 1:1.

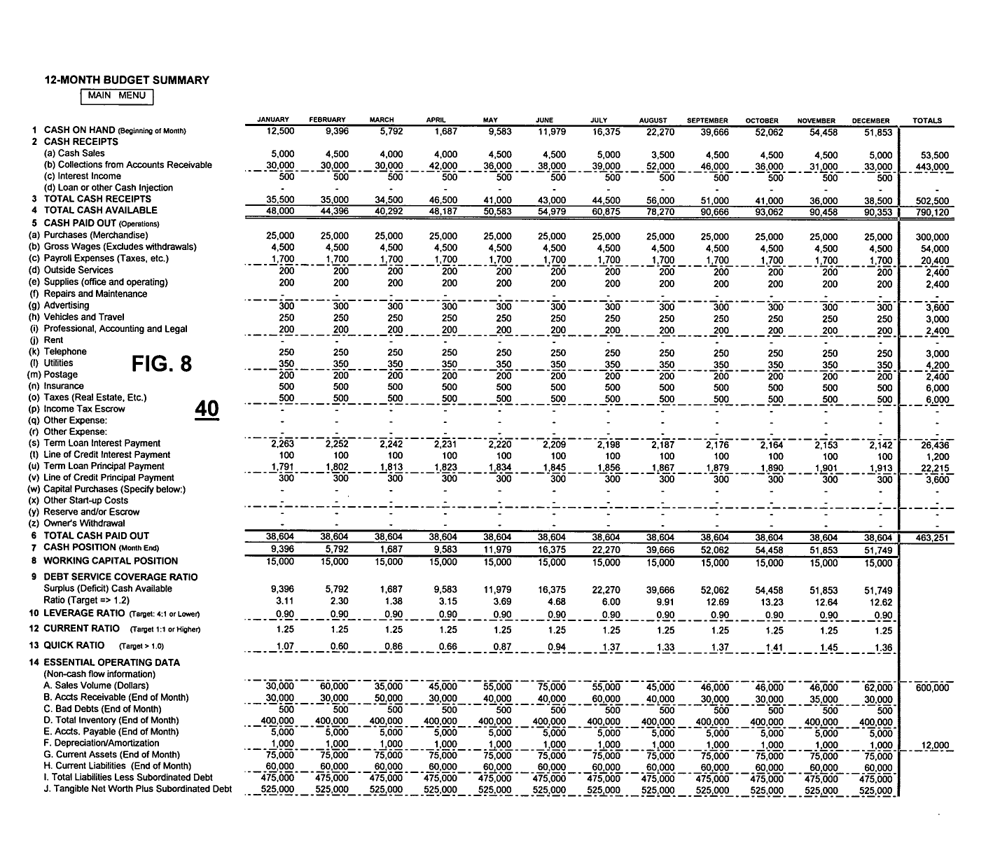

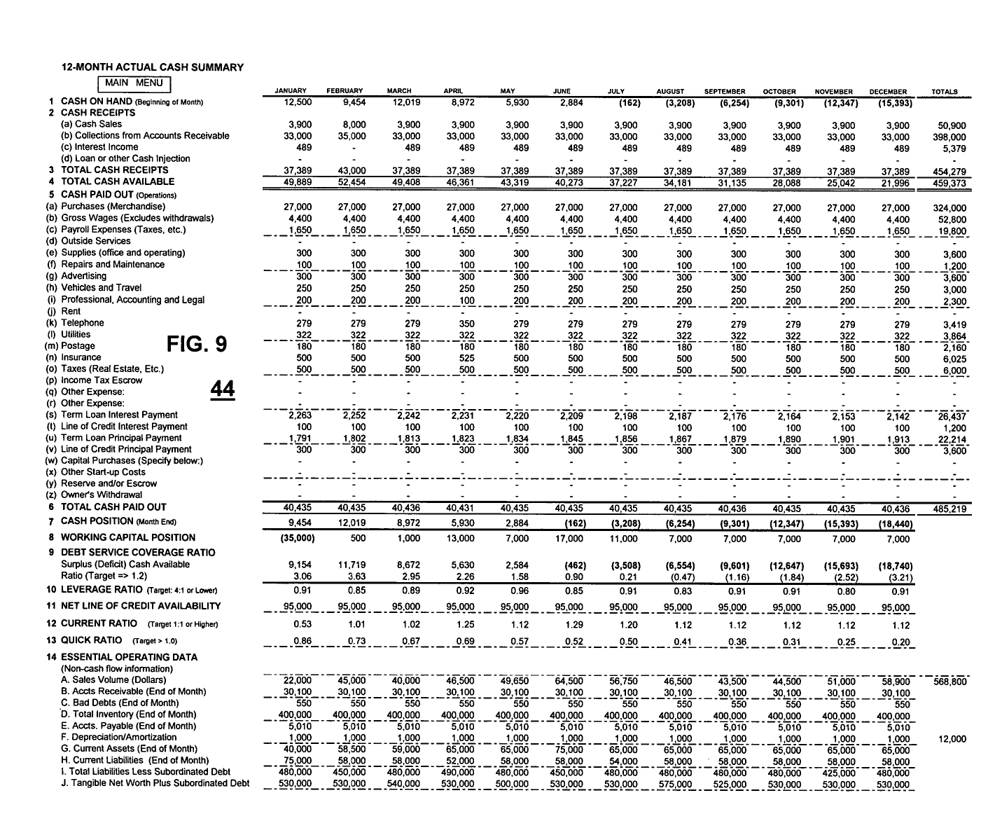

A “12 Month Budget Summary” button 46 (FIG. 1) is clicked on to reach a complete 12-Month Budget Summary screen 40, shown in FIG. 8. The 12-month budget summary screen 40 displays information entered in the screens shown at FIGS. 2, 4 and 7 for each month of the year. A “12 Month Actual Cash Summary” button 42 (FIG. 1) is clicked on to reach a 12 Month Actual Cash Summary screen 44, shown in FIG. 9. The 12 Month Actual Cash Summary screen 44 displays information entered in FIGS. 2, 4, 5 and 7 for each month of the year.

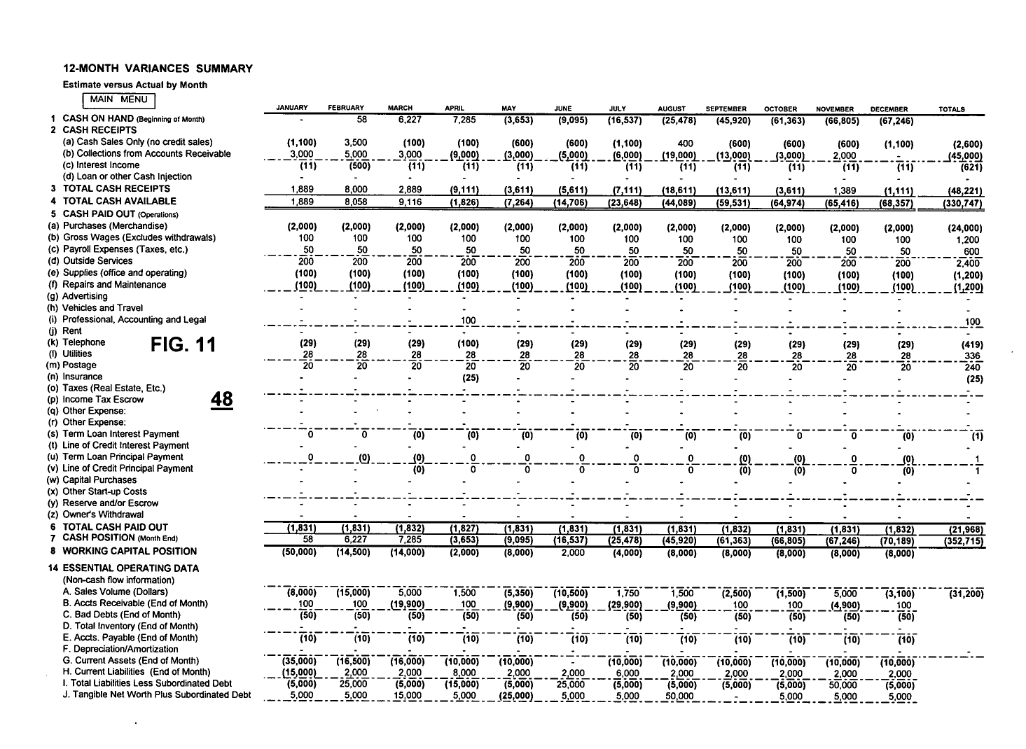

A “12-Month Variances Summary” button 38 (FIG. 1) is clicked on to reach a 12-Month Variances Summary screen 48, shown at FIG. 11. The Variances Summary screen 48 displays the difference between actual and budget for each line item of information for each month of the year.

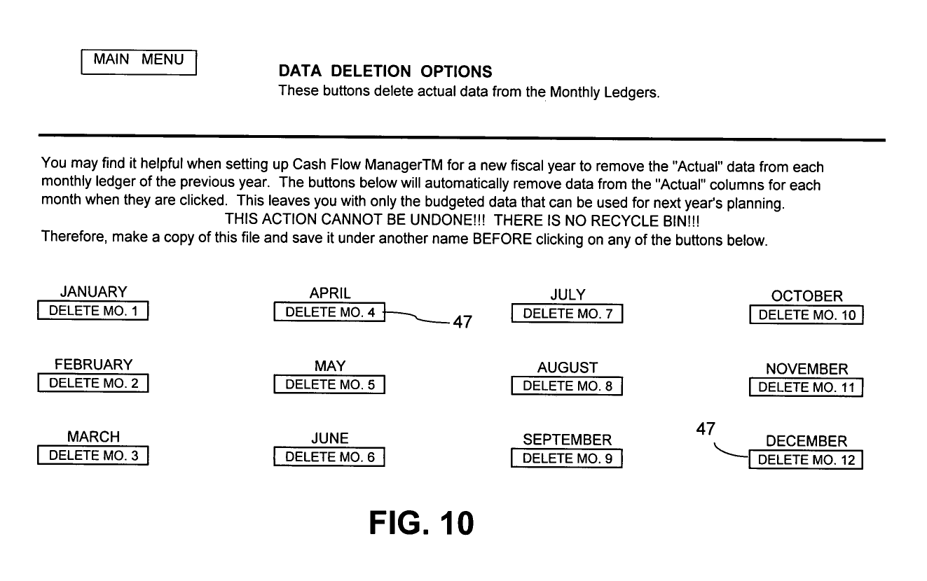

A data deletion button 45 (FIG. 1) is clicked on to reach a screen, shown at FIG. 10, where a group of monthly deletion buttons 47 are available. When starting a new fiscal year it may be helpful to remove actual data from the actual columns of each monthly ledger of the previous year in one step. These buttons 47 provide that functionality.

An About Priora CFM LLC button 51 is provided, to give the user information about the company offering the software.

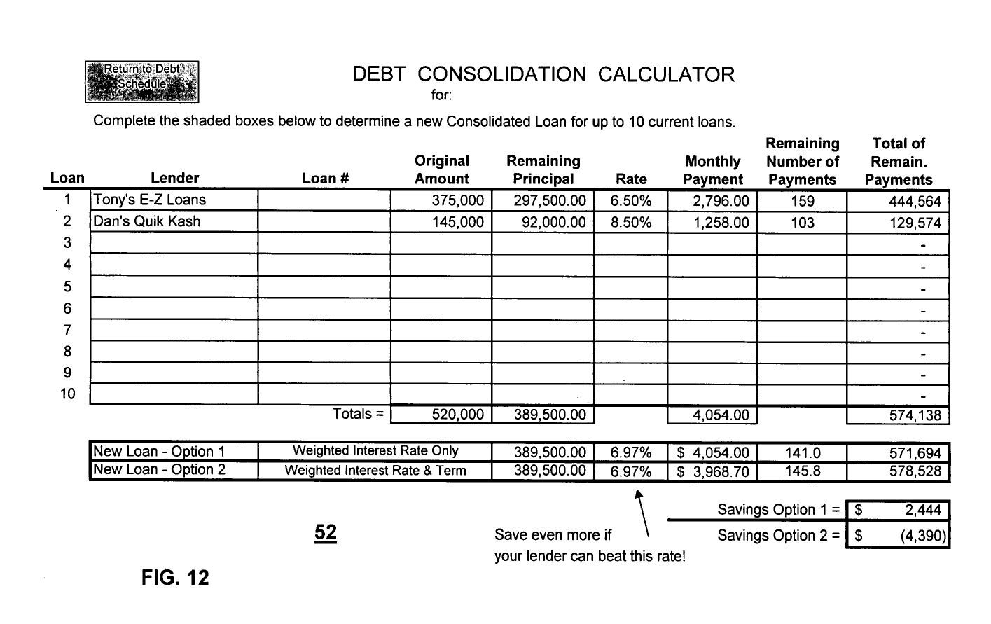

A “Debt Consolidation Calculator” button 50 (FIG. 4A) is clicked on to arrive at a Debt Consolidation Summary screen 52, shown in FIG. 12. This debt consolidation feature is another of the unique and valuable features of the invention. According to the invention, the debt consolidation calculator 52 uses weighted averages to show a user that a number of individual loans, with different remaining balances, interest rates and maturities, and therefore different payments, could be consolidated at a single interest rate and a single payment over an amortization period that blends all the individual loan amortization periods. By consolidating the loans in this manner, the user can save a substantial amount of interest, or can substantially reduce the total cash paid out in monthly payments, that is, reducing the demands on the user's cash flow, while still reducing the overall period of the longest loans and possibly reducing interest costs. At the same time, consolidating up to ten loans in this manner will not increase or reduce the cash flow requirement of all ten individual loans, that is, until the payment schedule of the loan with the shortest term is exhausted.

As shown in FIG. 12, information concerning each loan is entered into the debt consolidation calculator screen 52. The information entered includes lender, loan number, original loan amount, remaining principal, interest rate, monthly payment and remaining number of payments. The Total of Remaining Payments for each loan is calculated by multiplying the monthly payment by the remaining number of payments. The debt consolidation calculator 52 calculates two options for new loans. One option is calculated with a weighted average interest rate, while the other option is calculated with a weighted average term as well as a weighted average interest rate as a percentage of the total individual loans. The weighting for both options is based on the remaining principal balances of the respective loans, as a percentage of the total of the amount of principal outstanding. As can be seen from FIG. 12, the overall cash flow does not change for the first option until the completion of the amortization of the shortest term loan.

Specifically, then, according to the invention, the debt consolidation calculator 52 performs the following calculations in Option 1. The remaining principal balances of all loans are totaled to produce a new consolidated loan amount. Then, for each loan, the interest rate is multiplied by the ratio of remaining principal for that loan to the new consolidated loan amount. The result of that calculation is totaled with the results of the same calculations for the other loans, to produce the weighted average interest rate for all the loans. Similar to the remaining principal balances, the monthly payments for all the loans are totaled, to arrive at a single monthly payment. Once these three figures (principal balance, weighted average interest rate, and payment amount) are arrived at, they are used to calculate the remaining number of payments. As can be seen by reference to FIG. 12, this results in a substantial reduction of interest to be paid, as well as a substantial reduction of the longest maturity term.

In the second option, a weighted average of the remaining number of payments is also calculated for all the loans, in the same manner as described above for the weighted average of the interest rates. Using the weighted average of interest rates and the weighted average of remaining number of payments, together with the total remaining principal to be paid, a new periodic payment is calculated. As can again be seen by reference to FIG. 12, while the interest reduction is not as great as with the first option, there is still a substantial savings of interest, but this time with a substantial reduction in the payment. The result is that several hundreds of dollars of cash flow, in the example shown, are freed for application to other cash flow requirements each month as opposed to waiting until the final payment (as in Option 1) to realize the savings or impact on cash flow. And the term of the consolidated loan under this second option is still shorter than the longest term of the individual loans. Another benefit of this debt consolidation calculator is that it is easier to compare the savings of the two options.

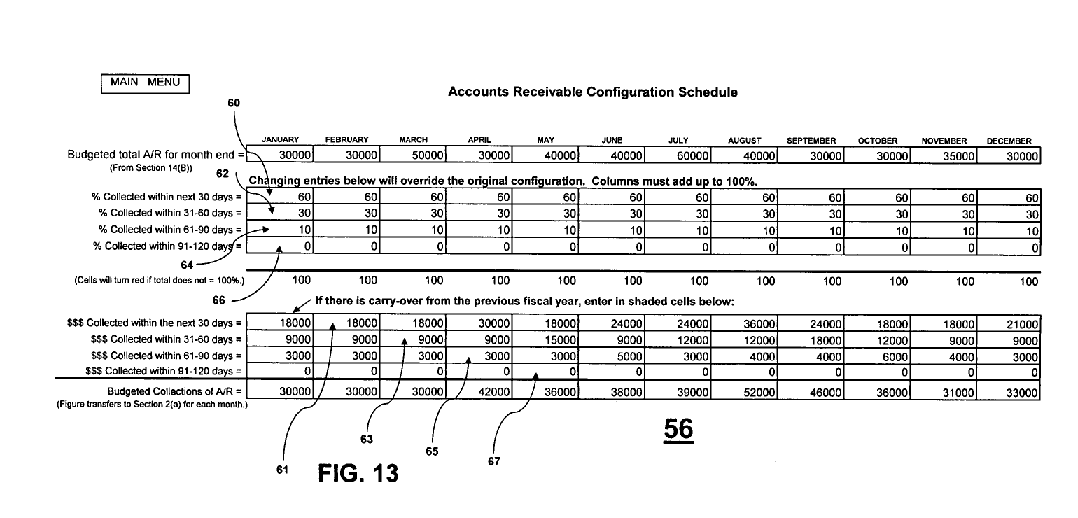

Referring again to FIG. 5, an “Accounts Receivable Configuration Schedule” button 54 is clicked on to reach an accounts receivable configuration schedule 56, which is shown in FIG. 13. The accounts receivable configuration schedule 56 allows a user to enter and change the percentage of funds expected to be received during different 30-day collection periods to view the resulting impact on cash position in row 7 of each monthly ledger (FIG. 7) each month. The percent expected to be collected in the first month (0-30 days) after a bill is sent out is entered in the second row 60 in the accounts receivable configuration schedule 56. The percent expected to be collected is multiplied by the budgeted total accounts receivable for the month end and transferred to the next subsequent month's budgeted collections 61. The percent expected to be collected in the next month (31-60 days) after the bill is sent out is entered in the third row 62 of accounts receivable configuration schedule 56. The percent expected to be collected is multiplied by the budgeted total accounts receivable for the month end and transferred to the second subsequent month's budgeted collections 63. The percent expected to be collected in the next month (61-90 days) after the bill is sent out is entered in the fourth row 64 of the accounts receivable configuration schedule 56. The percent expected to be collected during that period is multiplied by the budgeted total accounts receivable for the month end and transferred to the third subsequent month's budgeted collections 65. Finally, the percent expected to be collected in the next month (91-120 days) after the bill is sent out is entered in the fifth row 66 of the accounts receivable configuration schedule 56. The percent expected to be collected is multiplied by the budgeted total accounts receivable for the month end and transferred to the fourth subsequent month's budgeted collections 67. Similarly, each month has percentages in the second through fifth rows that affect respective later months' budgeted receipts in the four rows of the next lower section.

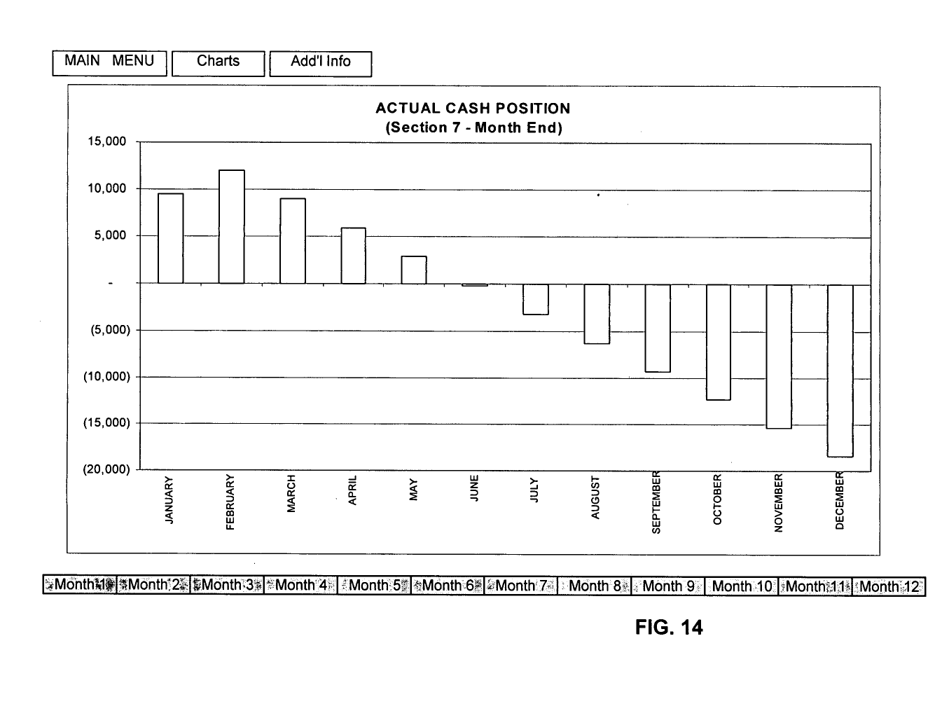

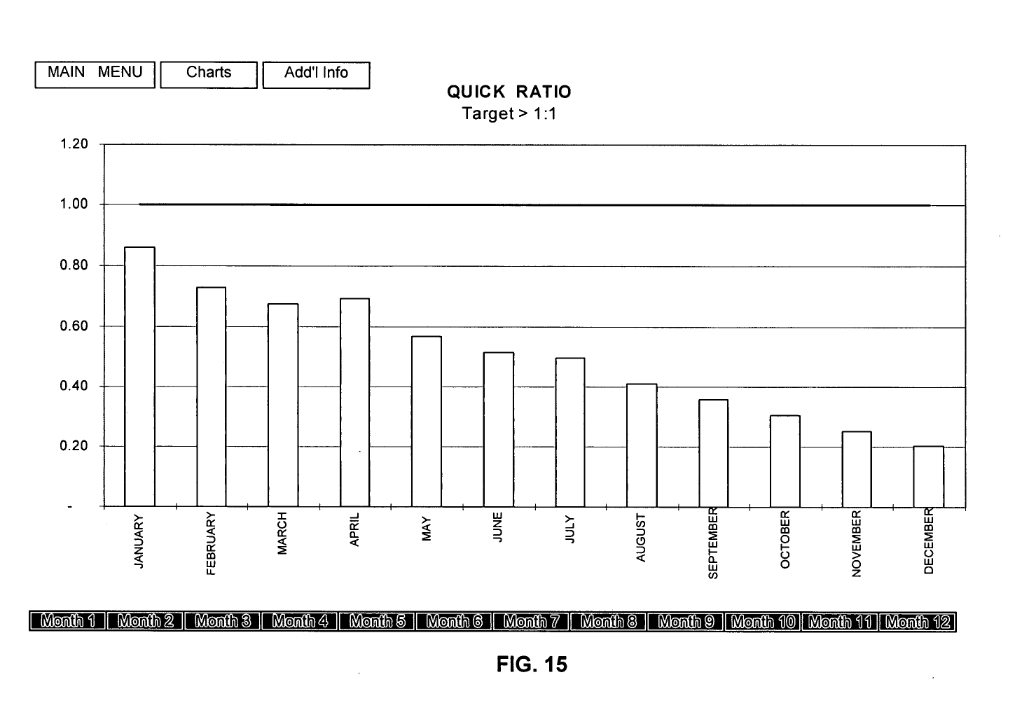

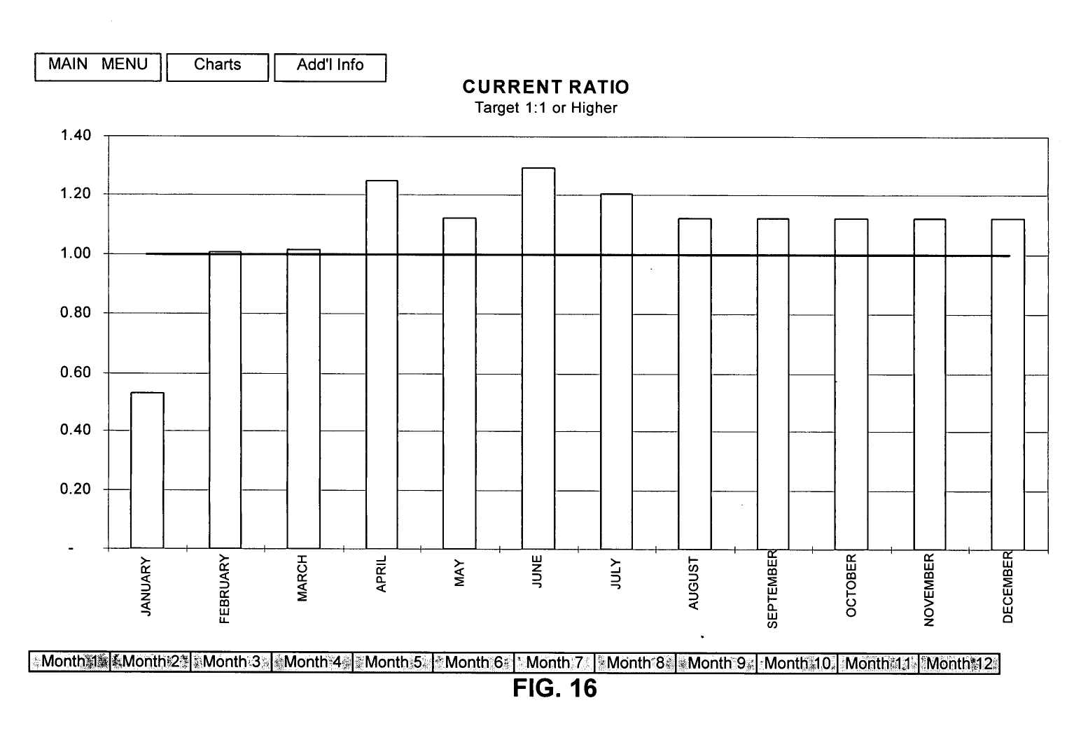

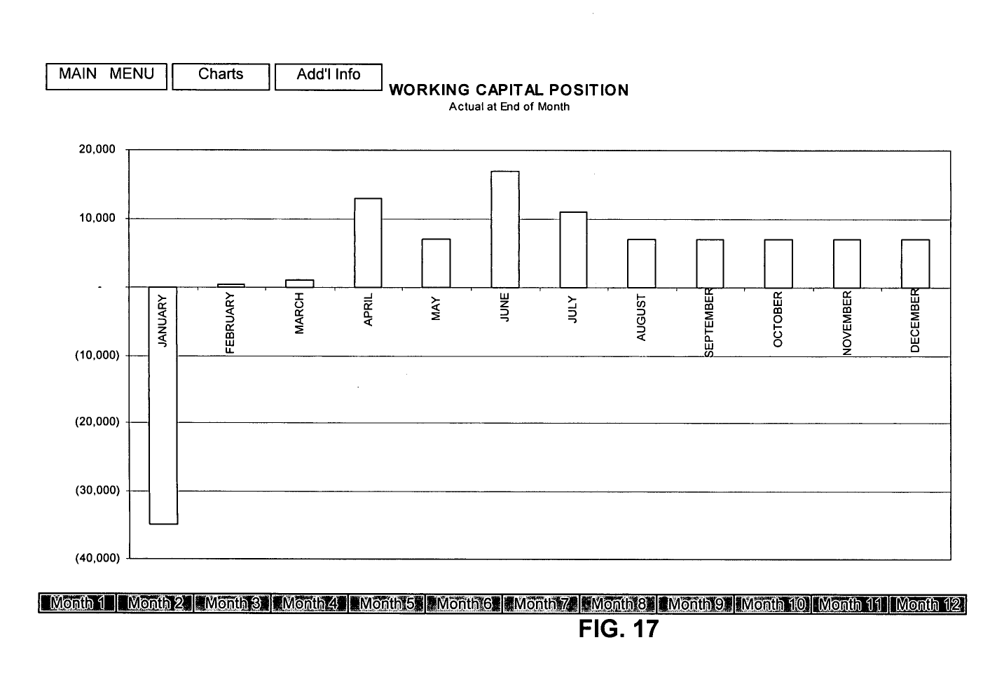

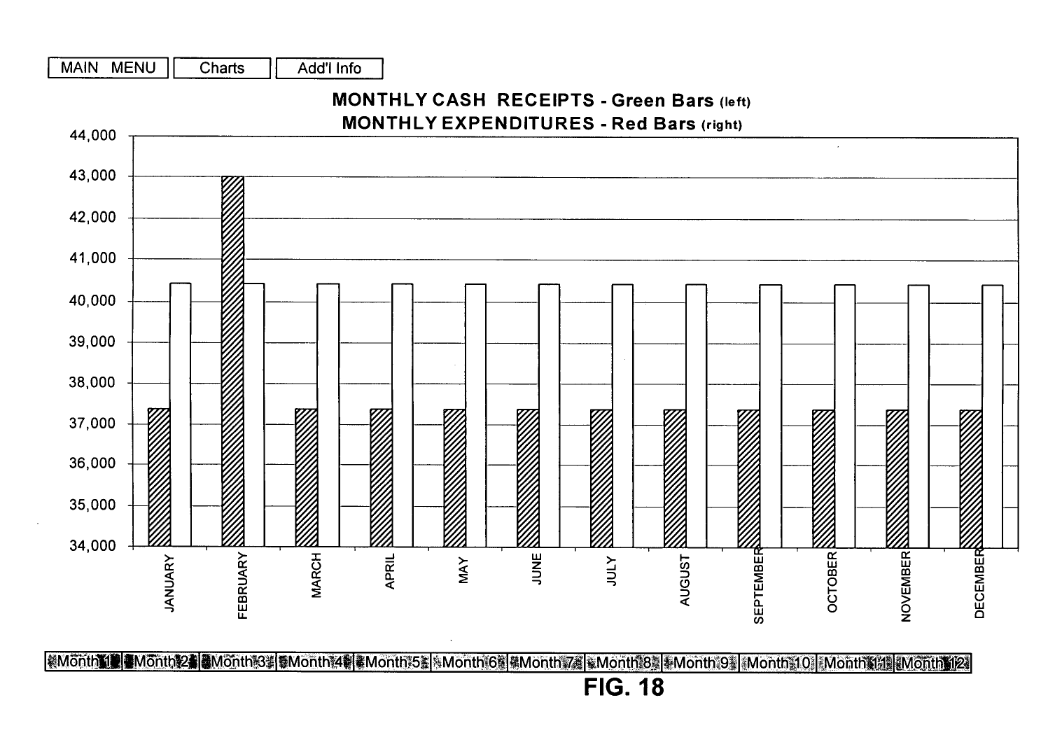

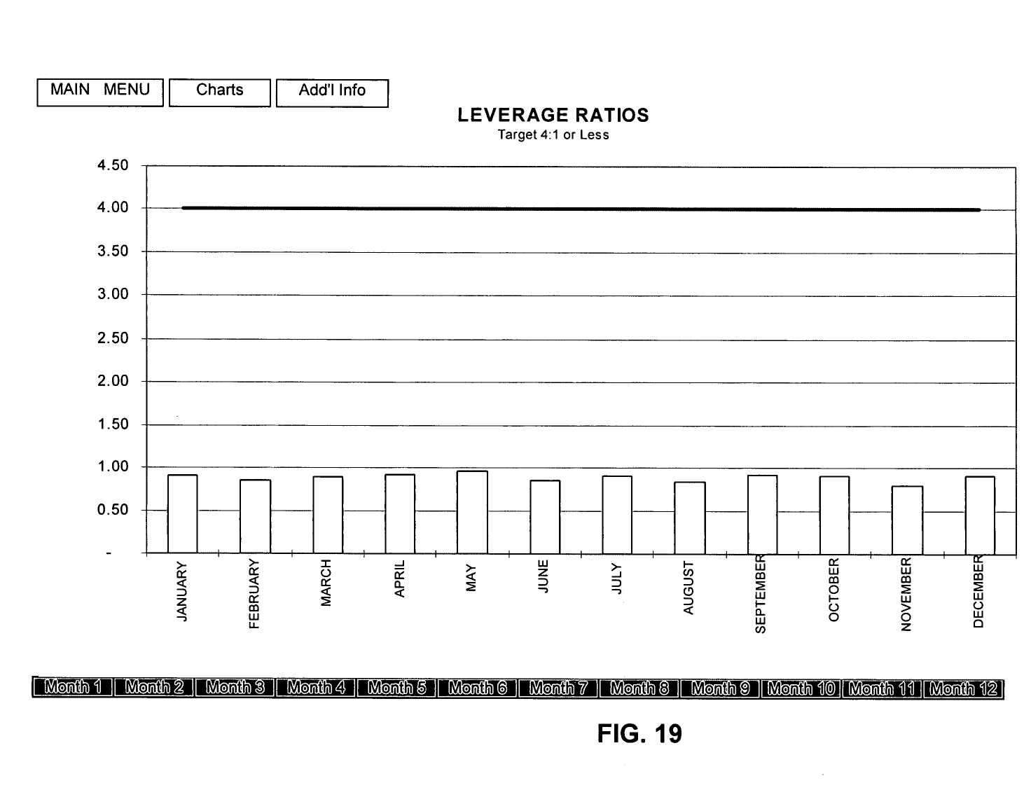

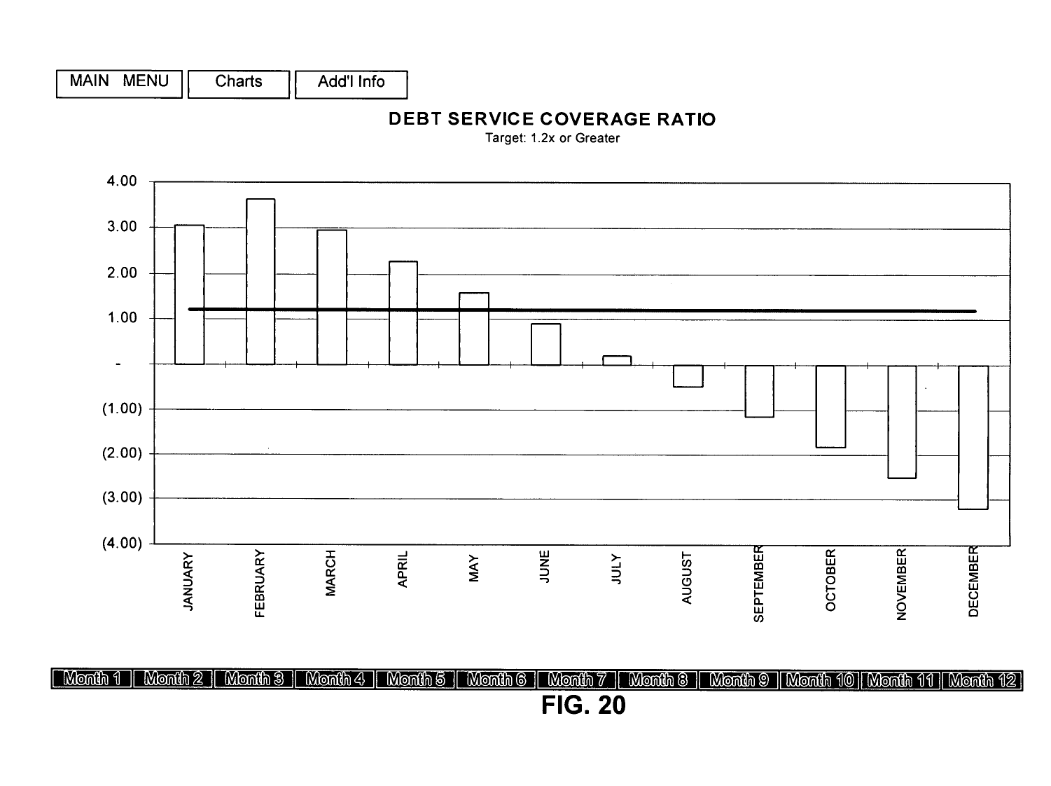

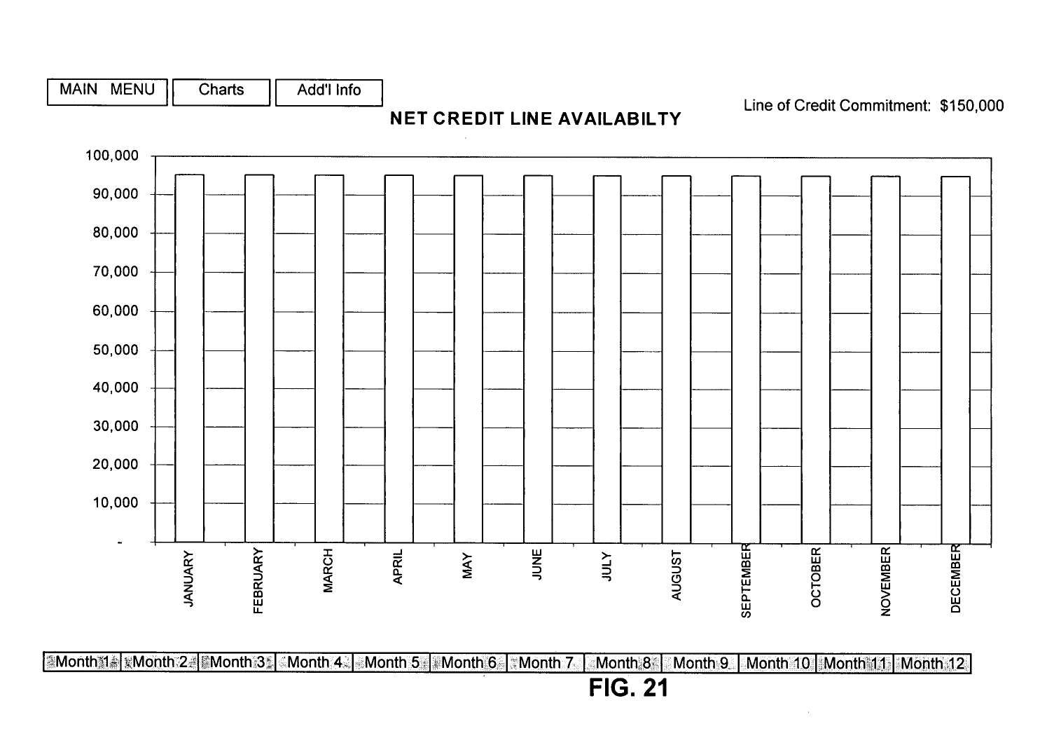

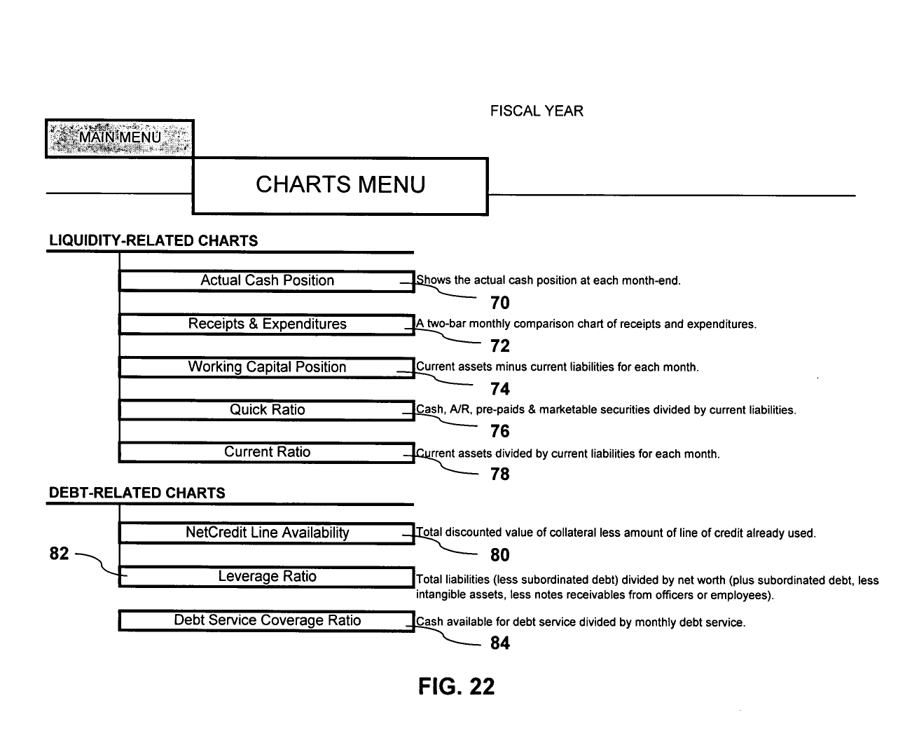

Clicking on the “Charts” button 58 (FIG. 1) brings the user to a menu of charts, shown in FIG. 22, from which each of the eight charts can be selected. Clicking on the Actual Cash Position button 70 takes the user to FIG. 14, which shows a bar chart of “Actual Cash Position” for each month of the year, using cash on hand from the monthly ledger screens as shown at line 7 of FIG. 7. Clicking on the Receipts and Expenditures button 72 takes the user to FIG. 18 which shows a bar chart of monthly cash receipts, and adjacent monthly expenditures from the monthly ledger screens as shown at FIG. 7 for each month of the year. Clicking on the Working Capital Position button 74 takes the user to FIG. 17 which shows a bar chart of “Working Capital Position” for each month of the year from the monthly ledger screens as shown at FIG. 7. Clicking on the Quick Ratio button 76 takes the user to FIG. 15 which shows a bar chart of “Quick Ratio” for each month of the year from the monthly ledger screens as shown at FIG. 7. Clicking on the Current Ratio button 78 takes the user to FIG. 16 which shows a bar chart of “Current Ratio” for each month of the year from the monthly ledger screens as shown at FIG. 7. These two charts each compare the “actual” ratio to a standard of performance, a ratio of 1:1. Clicking on the Net Credit Line Availability button 80 takes the user to FIG. 21 which shows a bar chart of net credit line availability from the monthly ledger screens as shown at FIG. 7 for each month of the year. Clicking on the Leverage Ratio button 82 takes the user to FIG. 19 which shows a bar chart of leverage ratios from the monthly ledger screens as shown at FIG. 7 for each month of the year. In this chart the “actual” ratio is compared to an industry standard ratio of 4:1. Clicking on the Debt Service Coverage Ratio button 84 takes the user to FIG. 20 which shows a bar chart of debt service coverage ratios from the monthly ledger screens as shown at FIG. 7 for each month of the year. In this chart the “actual” ratio is compared to an industry standard of 1.2:1.

It is preferable that this invention, including the method and program for managing cash flows, be used in conjunction with a monthly income statement, a balance sheet, an aging of accounts receivable and a monthly cash disbursements journal, as produced by the accounting system utilized by the user.

While particular embodiments of the invention have been shown and described, changes and modifications may be made without departing from the invention in its broader aspects, and therefore, the aim in the appended claims is to cover all such changes and modifications as fall within the true spirit and scope of the invention.

I claim:

1. A method of managing cash flow, with respect to a fiscal year, which fiscal year is made up of months, each month having at least one account with budget figures assigned to it, the method comprising the steps of:
determining the difference between a budget year-to-date figure and a corresponding actual year-to-date figure of the at least one account, for a particular month, to determine a variance year-to-date figure; and
dividing the variance year-to-date figure by the number of months remaining in the year to produce a figure related to the impact on budget of that variance.

2. A method as recited in claim 1 further comprising the step of adjusting the budget figure for at least one of the remaining months by the figure related to the impact on budget of that variance.

3. A budget adjustment calculator, comprising:
means for determining the difference between a budget year-to-date figure for a particular fiscal year and month, and an actual year-to-date figure for that same fiscal year and month, for at least one account, to determine a variance year-to-date figure for that fiscal year and month; and
means for dividing the variance year-to-date figure by the number of months, if any, remaining in the fiscal year to produce a budget impact figure.

4. A budget adjustment calculator as recited in claim 3 further comprising means for adjusting the budget figure for at least one of the remaining months by the budget adjustment figure.

5. An apparatus for managing business cash flow, for a business having accounts receivable, the apparatus comprising:
a first percentage of accounts receivable planned to be collected during a first period of time,
a second percentage of accounts receivable planned to be collected during a second period of time;
means for multiplying the accounts receivable by the respective receivables percentage for each of the periods to provide an accounts receivable amount expected to be collected for each period.

6. An apparatus for managing business cash flow as recited in claim 5, further comprising a third percentage of accounts receivable planned to be collected during a third period.

7. An apparatus for managing business cash flow as recited in claim 6, further comprising a fourth percentage of accounts receivable planned to be collected during a fourth period.

8. A method of calculating the savings from consolidating at least two loans, each of the loans having a remaining principal balance, an interest rate, a periodic payment amount, and a remaining number of payments, the method comprising the steps of:
summing all remaining principal balances to provide a new consolidated loan amount;
calculating a weighted average of the interest rates of all the loans to provide a new consolidated loan rate;
totaling all monthly payments on current loans to provide a new periodic consolidated loan payment;
using the new consolidated loan amount, the new consolidated loan rate and the new periodic consolidated loan payment to calculate a new consolidated remaining number of payments;
summing the total of remaining payments for all existing loans to provide a remaining total of payments for existing loans;
multiplying the new loan payment by the new remaining number of loan payments to provide a total of payments for the new consolidated loan; and
subtracting the remaining total of payments for new consolidated loan from the total of payments the existing loans to arrive at a consolidated savings.

9. A method of calculating the savings from the consolidation of at least two existing loans, each of the existing loans having a remaining principal balance, an interest rate, a periodic payment amount, and a remaining number of payments, the method comprising the steps of:
summing all remaining principal balances to provide a new consolidated loan amount;
calculating a weighted average of the interest rates of all the existing loans to provide a new consolidated loan rate;
calculating a weighted average of the remaining number of payments of the existing loans to provide a new consolidated remaining number of payments; and
using the new consolidated loan amount, the new consolidated loan rate and the new consolidated remaining number of payments to calculate a new consolidated periodic payment amount.

10. A method as recited in claim 9, further comprising the steps of:
summing the total of remaining payments for all existing loans to provide a remaining total of payments for existing loans;
multiplying the new loan payment by the new remaining number of loan payments to provide a total of payments for the new consolidated loan; and
subtracting the remaining total of payments for the new consolidated loan from the total of payments the existing loans to arrive at a consolidated savings.

11. A debt consolidation calculator for calculating the savings from consolidating at least two existing loans, each of the existing loans having a remaining principal balance, an interest rate, a periodic payment amount, and a remaining number of payments, comprising:
means for summing all remaining principal balances to provide a new consolidated loan amount;
a calculator for calculating a weighted average of the interest rates of all the existing loans to provide a new consolidated loan rate; and
means for using the new consolidated loan amount and the new consolidated loan rate to calculate a new consolidated periodic payment amount.

12. A debt consolidation calculator as recited in claim 11, further comprising:
means for calculating a weighted average of the remaining number of payments of the existing loans to provide a new consolidated remaining number of payments; and
means for using the new consolidated loan amount, the new consolidated loan rate and the new consolidated remaining number of payments to calculate a new consolidated periodic payment amount.

13. A debt consolidation calculator as recited in claim 12, further comprising means for subtracting the remaining total of payments for the new consolidated loan from the total of payments the existing loans to arrive at a consolidated savings.

14. A debt consolidation calculator as recited in claim 11, further comprising:
means for summing the total of remaining payments for all existing loans to provide a remaining total of payments for existing loans; and
means for multiplying the new consolidated periodic payment by the new consolidated remaining number of payments to provide a total of payments for the new consolidated loan.

15. A debt consolidation calculator as recited in claim 14, further comprising means for subtracting the remaining total of payments for the new consolidated loan from the total of payments the existing loans to arrive at a consolidated savings.
